(19) United States
(12) Patent Application Publication
(10) Pub. No.: US 2017/0300924 A1
(43) Pub. Date: Oct. 19, 2017

(54) SYSTEM FOR AUDIT RECOVERY

(71) Applicant: Management Systems Resources Inc., Toronto (CA)

(72) Inventors: Rajiv MANUCHA, Toronto (CA); Steven Lloyd CROZIER, Toronto (CA); Antonio GIULIANO, Bolton (CA)

(21) Appl. No.: 15/097,776

(22) Filed: Apr. 13, 2016

(51) Int. Cl. G06Q 30/00; G06F 17/30; G06Q 10/08

(52) U.S. Cl. CPC G06Q 30/018; G06Q 10/0831; G06F 17/30377; G06F 17/30528; G06F 17/30554

(57) ABSTRACT

A duty recovery system that maintains historical information to improve the duty recovery.

### CROSS-REFERENCE TO RELATED APPLICATIONS

None.

### BACKGROUND OF THE INVENTION

In the global marketplace for goods a company tends to source the goods from different available sources located at different locations around the world. In some cases, a United States entity is able to source the goods from another location within the United States. In other cases, a United States entity is able to source and import the goods from another location outside of the United States. In such a case, the importation of goods from outside the United States is subject to many U.S. Customs regulations. One of these customs regulations is based upon a classification system generally referred to as the Harmonized Tariff Schedule (HTS) codes. The HTS code classifies different goods using 10-digit HTS codes. Among other things, these codes are used to determine the applicable tariff rates on different types of goods that are imported into the United States. The task of selecting the appropriate HTS codes is complicated and prone to errors.

Importers of foreign goods frequently use customs brokers to act as an agent between the importer and the U.S. Customs and Border Protection, which is a part of the Department of Homeland Security. The customs brokers often ensure that that the rules and regulations are complied with which entails, in part, gathering and providing information regarding the goods to be imported to customs agents at the U.S. Customs department. Some of the information being provided is the HTS codes determined by the customs brokers together with other information, such as attribute classifications. The attribute classifications may include, for example, NAFTA certificates, anti-dumping, and Department of Transportation specifications. As identified, the task of selecting the appropriate HTS codes is further complicated by the additional attribute classifications. The task of selecting the appropriate HTS codes and attribute classifications is further complicated by the interpretations of the above as exemplified by the U.S. Custom's Customs Rulings which are well in excess of 150,000 different rulings.

After completing the appropriate documentations for the goods, the customs broker reports the classifications to the U.S. Customs, and arranges for the payment of any duties owed on behalf of the company based upon the reported classifications. Often, the information provided to the U.S. Customs is incorrect, or fails to conform to the actual facts regarding the nature of the imported goods. For example, the customs broker may mischaracterize the number of goods within a particular package or otherwise not properly characterize the component parts of a complicated component, such as a vehicle frame. In addition, as further information becomes available the previously assigned HTS codes may need to be updated, which tends to occur when additional third party information becomes available. Some of the information may include updated information regarding the goods, U.S. Customs Rulings, and the like.

This process for the importation of goods may be generally separated into four different phases of operation. The first phase of the operation is a pre-entry or classification process. The second phase of the operation is an entry process. The third phase of the process is a post-entry process (including audits and payment balancing). The fourth phase of the process is an amendment process. Each of these phases tends to be rather complicated, and is prone to errors that impact the other phases.

With the complexities inherent in the process of the importation of the goods together with the different phases of the process, it is problematic to efficiently process the voluminous materials to pay the appropriate customs duties. In many cases, inaccurate data is being provided to U.S. Customs by the customs broker resulting in the entity paying erroneous duty amounts as a result. Thus, an efficient process is desirable to provide meaningful information such that the customs broker may submit accurate information for the calculation of duties, and/or to correct improperly paid duties, such as by determining and paying an additional amount of duty owed or determining and receiving a superfluous amount of duty paid.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates entities involved with importing goods.

FIG. 2 illustrates data for importation.

FIG. 3 illustrates a data importation process.

FIG. 4 illustrates a data selection process.

FIGS. 5A-5D illustrate database tables.

FIG. 6 illustrates a wildmap table.

FIG. 7 illustrates a main page header.

FIG. 8 illustrates DRA Repository Filters.

FIG. 9 illustrates DRA Repository Filters.

FIG. 10 illustrates HS/KB Filters.

FIG. 11 illustrates DRA Repository Filters.

FIG. 12 illustrates Keyword Filters.

FIG. 13 illustrates a Summary Page.

FIG. 14 illustrates US Ruling Matches.

FIG. 15 illustrates Rulings by HS.

FIG. 16 illustrates Rulings by Keyword

FIG. 17 illustrates GPT Analysis.

### DETAILED DESCRIPTION OF PREFERRED EMBODIMENT

All products that are shipped to the United States are typically categorized for the U.S. Customs in a suitable manner, such as by the type of product (e.g., goods) in accordance with the guidelines included in the Harmonized Tariff Schedule. In this process, called classification, the importer may assign an HTS code to all imported merchandise. For increased efficiency, the classification of a product should be completed prior to the product being shipped to the United States.

The classification process identifies the nature of the products, the location that they were made, and what the products are made from. In addition, the classification process may also include information related to anti-dumping duties, countervailing duties, governmental agency regulations, and whether eligible for reduced duties under special trade agreements. Also, the classification process also determines how much duty is owed to the U.S. Customs which ensures the accuracy and completeness of classification of the products.

As such, under U.S. Customs' guidelines, importing companies may be responsible for utilizing all available resources to determine correct classification. In addition, companies, should be able to provide a legitimate rationale for all HTS assignments at the time of classification, and offer proof of consistency in assigning HIS codes for like components.

The importation of goods includes other processes than classification. One of the other processes is an entry phase that may include a set of processes and procedures where data related to particular shipments and associated documentation is recorded and maintained by the importing company. Entry packets are then submitted by a customs broker to the U.S. Customs. The U.S. Customs may audit the products and the entry packets, which if irregularities are determined, the customs broker submits an amended entry packet. As it may be observed, the entry process is prone to errors in the identification of the goods, and the amount of duty owed, which may or may not be determined during the entry phase.

Another of the other processes is a post-entry phase where the customs broker may obtain additional information related to the importation of the goods. The additional information may be provided, for example, by the receiver of the goods. For example, the receiver of the goods may compare the actual number of products received to the number of items included on the materials provided to the U.S. Customs during importation. As such discrepancies or other errors are identified during post-entry audits, and the shortages or overages in the tariffs are identified, the customs broker may fill out amendment materials to bring these discrepancies to the attention of the U.S. Customs to seek a refund (e.g., generally referred to as reclaimed) or otherwise pay additional duties. As it may be observed, the post-entry process is prone to errors in the identification of the goods which may or may not be determined during the post-entry phase. Moreover, the sheer volume of data precludes a manual exhaustive approach. By way of example, a large importer such as a department store may have tens of millions of lines of submission data which may be reviewed. At any reasonable review rate it would likely take a year or more for a reviewer to perform even a cursory review the lines of the submission data.

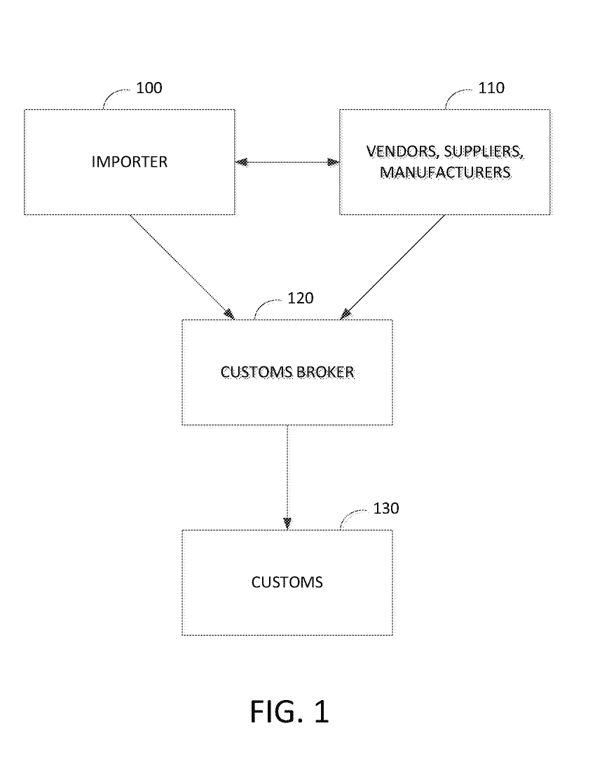

Referring to FIG. 1, the principal entities involved in the typical importation process is illustrated. An importer 100 may include a company including divisions thereof operating domestically or internationally. The importer 100 may also employ its own customs department or use a separate custom's broker to manage different portions of the overall importation process. When the importer wants to import a shipment of merchandise, it may provide relevant information about the shipment and its classification criteria to the customs broker 120. The customs broker obtains this information from the importer 100 and, through the importer 100, separate vendors, suppliers, foreign manufacturers, and freight forwarders 110, may identify information pertinent to the shipment earmarked for entry into the United States. The customs broker prepares the appropriate paperwork for presentation to U.S. Customs 130 for the purposes of determining the correct duty to be paid. The forms prepared or presented by the customs broker may include a CF7501 form (also known as a 7501 form), commercial invoice, and shipment manifest.

After the duty is paid and the products are imported from a port of origin into the United States at a designated port, various types of audits may be performed by the importer 100 or by U.S. Customs 130 to ensure that the goods entering the country are appropriately classified per U.S. Customs regulations and that the proper tariffs are paid by the customs broker 120.

An auditor may not suitably review the lines by simply viewing each of the lines of the submission data. To perform a more suitable review the auditor needs to recognize the line contains a part or parts that are likely to qualify for re-classification. To recognize such lines among the multitude of other lines, the auditor needs to have memorized a huge number of rulings, part numbers, and part descriptions (among other data) in order to recognize an eligible part. The auditor also needs to review all new and pending rulings that are periodically submitted to government agencies which may likewise impact whether a part or parts may quality for re-classification. Also, since the number of rulings tends to be in the 10 of thousands or more, and many of the rulings tend to be relatively complicated, the auditor can't realistically recall all of them or even a meaningfully significant portion of them.

To perform a more suitable review the auditor also needs to recognize the line contains a part or parts that are likely to result in whether enough duty was paid in an amount sufficient to justify the expenditure to seek to reclaim it. By way of example, many lines of the submission data may have a duty that was paid in an amount of generally $10. In many cases, if the part was resubmitted under a different more appropriate class, the duty may be less than $5. If there are only a limited number of such lines, each of which is scattered among the multitude of other lines, the auditor will likely ignore them since the time expended will result in a very minor reclaimed amount at a substantial effort. However, if there are a substantial number of such lines of a similar character scattered about the multitude of other lines then the time expended will result in a much more significant reclaimed amount, albeit still with a substantial effort. However, with suitable characterization of the submission data together with fully and partially automated systems the reclaimed amount may be determined in a more efficient and previously unattainable manner. Moreover, the similar characterized scattered lines may be gathered in a fully or partially automated system to reclaim a significant amount.

To further perform a suitable review the auditor needs to find the actual one or more rulings that apply to a particular reclaim and reference them in the submission to the agency. In this manner it is insufficient that the auditor remembers that a part may be suitable for reclassification, but needs to cite the appropriate ruling, HS codes, etc. in the submission. Unfortunately, the location of the appropriate rulings is a time consuming process that is prone to significant errors.

A duty recovery system is desirable to enhance the manner in which a client's past imports may be effectively reviewed to determine what duty refunds are due to the importer. One of the manners of duty recovery is based upon duty drawback. Duty drawback is a rebate of duty chargeable on imported material or excisable material used in the manufacturing of goods in and is exported. The exporter may claim drawback or refund of excise and customs duties being paid by his suppliers. The final exporter can claim the drawback on material used for the manufacture of export products. In case of re-import of goods the drawback can also be claimed. For example, one drawback is customs paid on imported inputs plus excise duty paid on indigenous imports. For example, another drawback is duty paid on packing material. Drawback is not allowed on imports obtained without payment of customs or excise duty. In the case of partial payment of customs and excise duty, rebate or refund can be claimed only on the paid part. In case of re-export of goods, it should be done within 2 years from the date of payment of duty when they were imported. 98% of the duty is allowable as drawback, only after inspection. If the goods imported are used before its re-export, the drawback will be allowed at a reduced percent.

Another of the manners of duty recovery is based upon free trade agreements. Free trade agreements, such as the North-American Free Trade Agreement (NAFTA), grant importers substantial or even complete reductions of customs duties on qualifying goods. In order to benefit from the advantages afforded under a free trade agreement, importers must ensure that their imported goods are covered by valid certificates of origin. If called upon, persons issuing free trade certificates of origin (exporters) must be prepared to provide to the U.S. Customs authorities, satisfactory evidence that the goods qualify under the rules of origin. Certification of the originating status of a good should be left to those persons possessing a sufficient knowledge of the free trade rules of origin, the harmonized system of tariff classification, customs valuation, and the finished goods.

Another of the manners of duty recovery is based upon customs tariff reclassification. If a product may be classified into a customs classification code that reduces the level of duty payable, a customs cost savings may be made for the future and in some instances for the recent past.

Another of the manners of duty recovery is based upon the country of origin reassessment. Where the country of origin of particular products may be established as being a country or territory with a preferential trade agreement with the importing country or block, duties may be recovered if a higher customs duty was paid.

Another of the manners of duty recover is based upon claiming the benefit of unused duty suspensions. Often importers are unaware of the existence of duty suspensions and therefore fail to claim their benefit at the time of importation which, in some instances, can be retroactively adjusted to obtain repayments.

Another of the manners of duty recovery is based upon refunds of antidumping and anti-subsidy duties. In those countries or blocs where a prospective antidumping and/or anti-subsidy (or countervailing) system is in place, refunds of these duties is possible where the dumping or subsidization margins have been reduced or eliminated.

The system may include an integrated web-based or server based application that is designed to improve, and facilitate the ease of, compliance with applicable duty recovery regulations. The system may embody a collection of networked database structures, including data storage devices for storing information. The system in one embodiment includes an integrated and user-friendly tool set to maintain customs-related records in a coherent and logical manner so that they can be easily identified, linked to other related documentation, audited, and modified, as appropriate. The system may also include an electronic system for providing efficient and more accurate audit procedures. Such audit procedures are made efficient and the associated changes to records, if any, may be included in an integrated system for cohesiveness and availability to relevant personnel. Navigation through this integrated system can be made relatively seamless. Entries and amendments into this system may be linked together in a logical structure so that the customs broker can identify and correct any discrepancies in records maintained in the system and/or presented to U.S. Customs, and accurately and more efficiently reimburse customs brokers for tariffs paid,

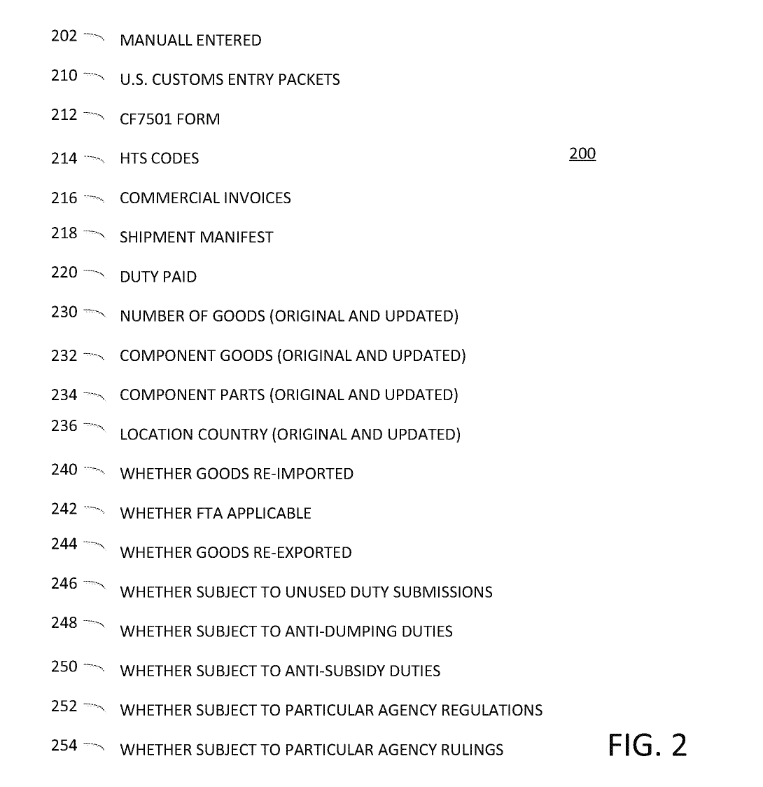

Referring to FIG. 2, the duty recovery system may include a process by which data is imported into the system 200. The customer data may be manually entered 202, if desired. The customer data may be imported based upon U.S. Customs entry packets 210, if desired. The entry packets may include, for example, the CF7501 form 212 which includes the HTS codes 214, commercial invoices 216, and a shipment manifest 218. The entry packets may also include the amount of duty paid 220 for particular goods.

The customer data may include information that was used as the basis of determining the information provided to the U.S. Customs, in addition to the data and forms provided to the U.S. Customs. For example, the information may include the number of goods 230 used as the basis of the entry packet, and may include an updated number of goods actually imported that was used as the basis for the entry packet. In many cases the number of goods actually imported is different than that used for the entry packets. For example, the information may include the component goods 232 for the entry packet and the component parts 234 for the component goods for the entry packet, and may include an updated identification of the component parts and an updated identification of the component goods. The customer data may include the location country 236 of the origin of goods used for the entry packet, if any, and may include an updated identification of the country of origin of the goods.

The duty recovery system may include an identification other regulatory matters, if any, that may have been included (either expressly or inherently) in the entry packet. The other regulatory matters may include, for example, whether the goods were re-imported 240; whether a free trade agreement (e.g., NAFTA) is applicable 242; whether the goods were re-exported 244; whether the goods were subject to unused duty submissions 246; whether the goods were subject to anti-dumping duties 248; whether the goods were subject to any anti-subsidy duties 250; whether the goods were subject to particular agency regulations 252; and whether the goods were subject to particular agency rulings 254.

The imported data, as illustrated in FIG. 2, in addition to any other desirable data may be obtained from any suitable source. For example, the data may be obtained from CBSA, EDI, other brokers, or otherwise.

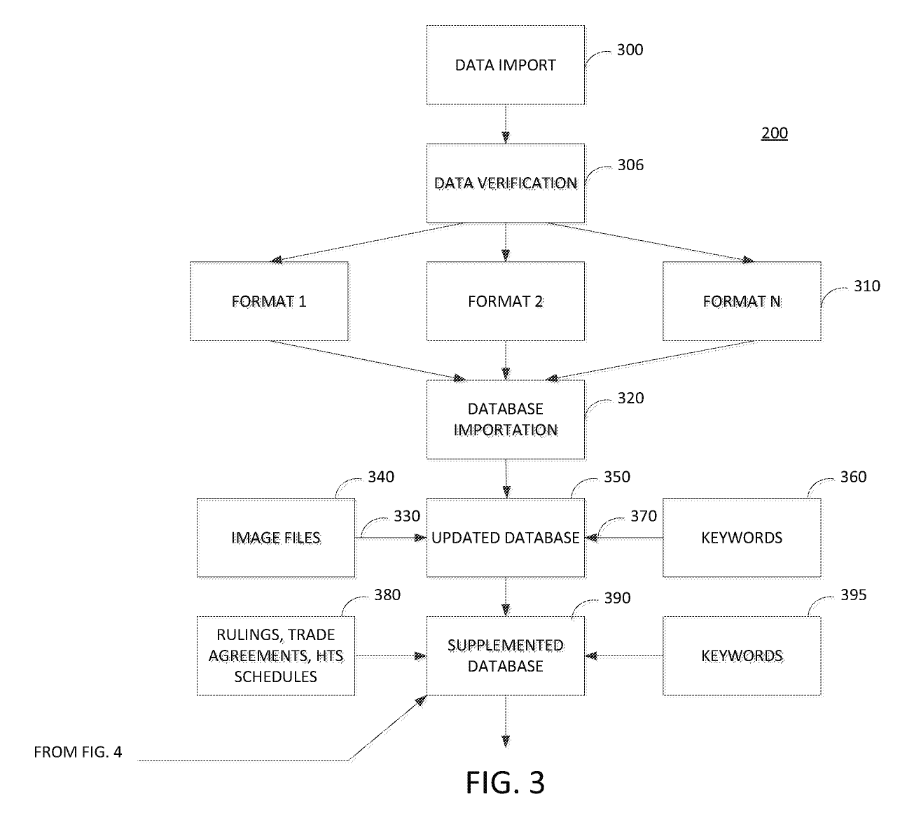

Referring to FIG. 3, the imported data 300 may be supplemented with additional information that is useful for duty recovery and the data may be verified to ensure the importation was proper 306. For example, the data verification may ensure the total on the source are imported properly. For example, the data may be verified to ensure that the data from the various sources relate to the same products, so that they are not inadvertently mixed with other products. For example, additional information related to the data may be added, as desired. The source of many of the data sources are provided in a variety of different formats. For example, some of the data may be in the form of a database, such as SQL data. For example, some of the data may be in the form of a spreadsheet, such as an Excel spreadsheet. For example, some of the data may be in a data file, such as CSV data. For example, some of the data may be in a word processing document, such as a MS Word file. For example, some of the data may be in the form of an XML format, such as an XML based text file.

The imported data 300 and the additional administrative data, if any, may be in a variety of different formats 310. Unfortunately, processing data that is maintained in a plurality of different formats in a plurality of different files is problematic to achieve a uniform and consistent result. In this manner, the various different files in the plurality of different file formats are preferably imported into a database 320, such as a SQL database. By way of example, XML templates may be used to identify and translate the data in the various files having different file formats to a suitable SQL format. In addition, a further validity check may be performed on the data within the SQL database, which being stored in a unified manner, facilitates the identification of issues with the data that would have not otherwise been apparent with the data being stored in various different files in a plurality of different file formats.

In many instances, the data is not in a form suitable for importation into a database as textual material. By way of example, some of the materials related to the contents in the database are scanned documents that are otherwise only readily available as an image. Some of the scanned documents may be the actual commercial invoices, importation documents, documents related to the contents of the materials, specifications of the products, drawings of the breakdown of a particular product such as the component parts of a multi-part product.

A linking process 330 may be used to link the image files 340 with the appropriate content within an updated database 350. Given the nearly endless number of potential image files, together with nearly endless data that is maintained in the database, it is desirable to link selected ones of the image files with selected ones of entries and/or clients of the updated database 350. In this manner, the amount of data that may be reviewed within the database and the image files for a particular entry and/or client is reduced to a manageable amount while maintaining that which is likely most relevant for the particular customs duties paid.

Based upon the linked 330 image files 340 additional specific content that was not otherwise available with the entry packets may be identified for particular content of the updated database 350. For example, the actual commercial invoice may include a specific identification of the particular goods, such as LED Lights rather than a more generic description of the lights which may have been included with the entry packets. This additional information from the image files 340 may be included as additional keywords 360 linked 370 to the updated database 350, and in particular linked to the appropriate content of the updated database 350 including the corresponding image file(s). The additional keywords 360 supplement the data that was originally included with the imported data. With the original imported data and the resulting supplement data as a result of reviewing the image files 340, the system is capable of determining the nature of the changes to the identification of the goods for the entry packets. In addition, when additional imported data is available, and in particular from the same entries and/or client, the system (or users) may predict the type of additional keywords that may be applicable to more accurately identify the goods. In addition, the system may suggest based upon historical data changes that should be made to the supplemented database and/or suggest likely changes to the previously paid duties based upon the historical data. The additional keywords are most preferably included in a format that is consistent with the HTS codes.

The updated database 350 may be further supplemented with rulings 380 based upon appeals from the U.S. Customs that are either won or lost to determine a supplemented database 390. The rulings 380 are identified for particular content (e.g., entities and/or clients) of the supplemented database 390. Otherwise, to merely have a full database of all the potentially available customs rulings 380 without a portion thereof being identified for particular content is not particularly useful. For a particular client (e.g., company) there tends to be a history of previous U.S. Customs rulings by one or more auditors with the U.S. Customs that are either their own appeals or otherwise relevant appeals from other companies for their importation of goods. The selection of particular rulings provides guidance that is often particularized for a particular client because the particular client tends to import the same or similar goods repeatedly over time. For a particular general type of products there tends to be a history of previous U.S. Customs rulings by one or more auditors with the U.S. Customs. These particular rulings provide guidance that is often particularized for a general type of products, because the general type of products tends to be imported repeatedly over time.

In addition to the particular rulings 380 being included associated keywords 395 may be included. The keywords 395 provide an indication of what the original classification of the goods was, what the amended classification of the goods are, together with other information. Also, the particular rulings 380 for a particular client may be unpublished, such as many of such rulings in Canada. While such non-published rulings in Canada are not binding on the U.S. Customs, since they both use a similar system, such un-published rulings tends to have some persuasive effect for U.S. Customs.

The supplemented database 390 may also be supplemented with historical HTS schedules 380. Over time the classification of particular goods may change, and based upon the timing of the duty recovery process, a historical HTS schedule may be used.

The supplemented database 390 may also be supplemented with trade rules 380. The trade rules may include a set of all agreements between the United States (or other country) and other countries. In addition, the supplemented database 390 may include a historical set of such trade rules.

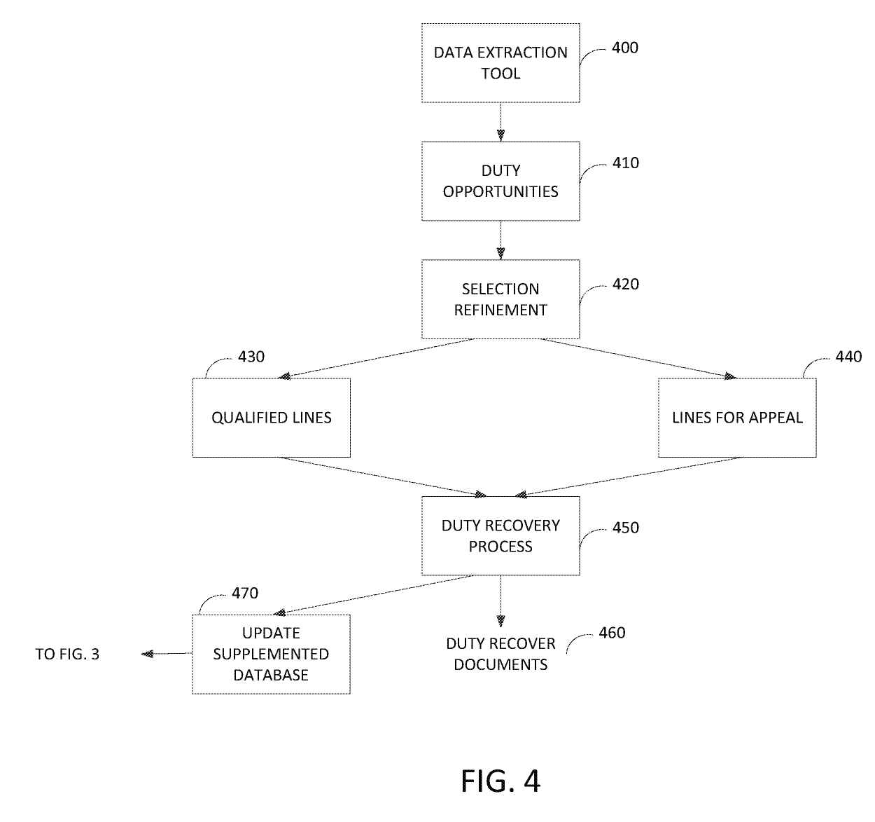

Referring to FIG. 4, a data extraction tool 400 may be used to request particular information from the supplemented database 390. The data extraction tool 400 may select a set of records, such as the records associated with an entry packet 210, to identify that data which may be useful in determining whether appropriate duties have been paid. The data extraction tool 400 may identify the duty paid 220 from within the supplemented database 380. The data extraction tool 400 may select other data items from the database, for example, the manually entered data 202; the CF7501Form 212; commercial invoices 216; the shipment manifest 218; the number of goods 230 included with the entry packet or as a result of subsequent inspection of the goods; the component goods 232 included with the entry packet or as a result of subsequent inspection of the goods; the component parts 234 of the goods included with the entry packet or as a result of subsequent inspection of the goods; the HTS codes 214; and the location of origin 236 included with the entry packet or as a result of subsequent inspection of the goods. In addition, the indications of whether the goods are re-imported 240; whether the goods are re-exported 244; whether there are relevant free trade agreements 242; whether there are unused duty suspensions 246; whether there are anti-dumping duties 248; whether there are anti-subsidy duties 250; whether there are relevant agency regulations 252; and whether there are relevant agency rulings 254. Further, the rulings, trade rulings, and HTS schedules 380 in addition to the image files 340 and keywords 360, 395, may be used. The selection of parts of these materials from the supplemented database 390 may be based, at least in part, upon the keywords that are provided to the imported data in such a manner that more relevant materials are selected than would have otherwise been selected.

The result of the data extraction tool is a set of duty opportunities 410. The duty opportunities 410 are those identified items that are likely to result in a change in the duty to be paid to the U.S. Customs. The duty opportunities may include, for example, potential classification identifications that may result in a duty change. The duty opportunities may include, for example, potential tariff agreement opportunities (or otherwise) that may result in a duty change. Preferably, the system determines the duty opportunities 410 on materials in addition to that associated with the particular entry packet. The additional materials are preferably a historical record of previous similar duty opportunities that were successful in obtaining a change in the duties paid for related goods and/or the same client. By way of example, if a change in the initial classification of Goods A for a particular client to a different classification resulted in a change in the duties paid, when the data extraction tool 400 processes the data for the same goods and/or the particular client, it should use such information to select appropriate duty opportunities 410. By way of example, the data extraction tool 400 preferably processes the data in a manner such that if some of the other imported data alone or in combination with other data, resulted in a change in the duties paid for the same goods and/or the particular client, it should use such information to select appropriate duty opportunities 410. In this manner, the data extraction tool 400 identifies items that may be claimable as a line with the U.S. Customs for a modification in the duties paid. However, at this stage it may be desirable to include an additional verification process prior to submission of the revisions to the U.S. Customs for a modification in the duties paid.

The duty opportunities 410 may be presented in an interface on a computing device to a user for selection refinement 420 and provide the user an opportunity to select those items, among the identified items, as likely being correct as a claimable item or otherwise a desire to include the selected items as a claimable item to the U.S. Customs. In some cases, it may not be desirable to include a particular item as a claimable item to the U.S. Customs for other business reasons. In this manner, those items which are not desirable to include as a claimable item are removed from the list so that a more focused review may be performed on the remaining items. In addition, the duty opportunities 410 may include links to the supporting documentation that is accessible through the selection refinement 420 that is used as a basis for making the determination.

Based upon the selection refinement 420 the selected items may be categorized differently. An interface on the computer system may be provided to identify a first set of selected items from the selection refinement 420 may be categorized as qualified lines 430. The qualified lines 430 are those that are likely to be approved by the U.S. Customs with a relatively high degree of certainty. An interface on the computer system may be provided to identify a second set of selected items from the selection refinement 420 may be categorized as lines for appeal 440. The lines for appeal 440 are those that are less likely to be approved by the U.S. Customs with a relatively high degree of certainty. In this manner, the items which are likely to be approved may be separated from those items which are less likely to be approved. The lines for appeal 440 have a greater likelihood of being initially rejected by the U.S. Customs and therefore may require an appeal process before being likely approved by the U.S. Customs.

After identifying the qualified lines 430 and the lines for appeal 440, the system processes the information and performs the calculations desired by a duty recovery process 450 to create the required documentation 460 (e.g., duty recovery documents) for a duty drawback for the qualified lines 430 and documentation for a duty drawback for the lines for appeal 440.

The duty recovery process 450 also identifies those items that are generally qualified lines 430 and lines for appeal 440 for the particular characteristics of the original data upon which they are based. This identified material is then used to update the supplemented database 470 process. This historical information based upon previous duty recovery processes provide useful information that assists in improving the results of subsequent duty recovery processes.

The system may use a relational database where the tables are separate entities that need to be joined for each specific query which limits or otherwise complicates the inter-relationships between the different tables of the database. For example, each relationship is answered by a specific query which needs to be re-coded and re-run, for example, if the auditor desires to check a set of different rulings. In contrast to a relational database it is preferable to use an organic associative database where all the data fields are related to all the other data fields. This provides substantially greater flexibility in the relationships between the different tables which is advantageous when which particular tables should be related to one another are not known ahead of time and tend to change based on a submission data file and/or based on each of the lines within the submission data file. By way of example, a ruling may be selected and the system identifies each of the importers that might be affected by the ruling, the amount of duty each paid for the specified HS codes, etc.

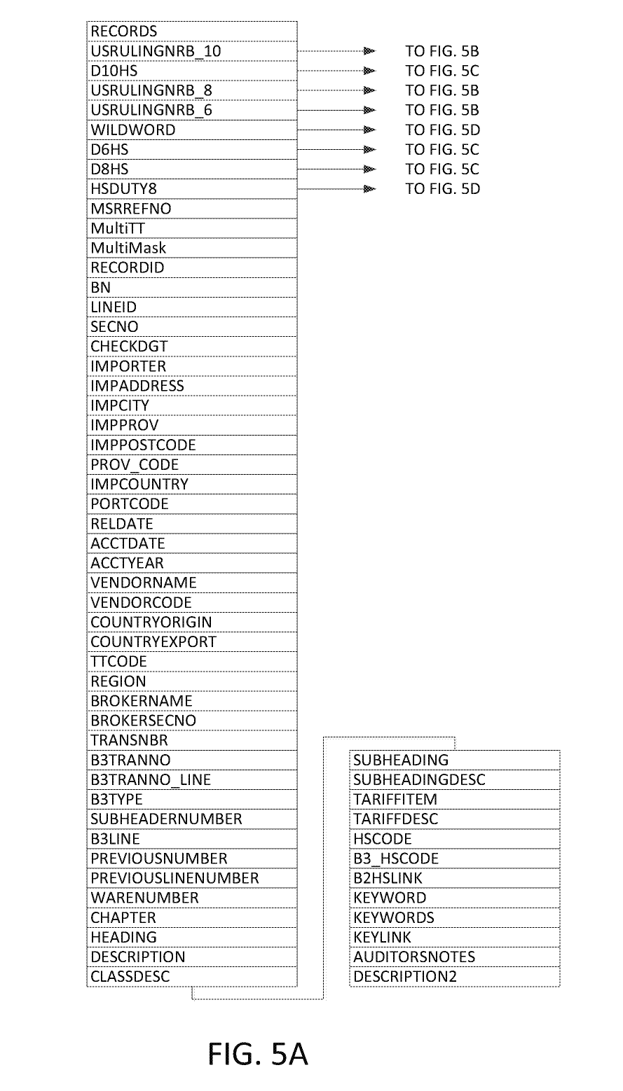

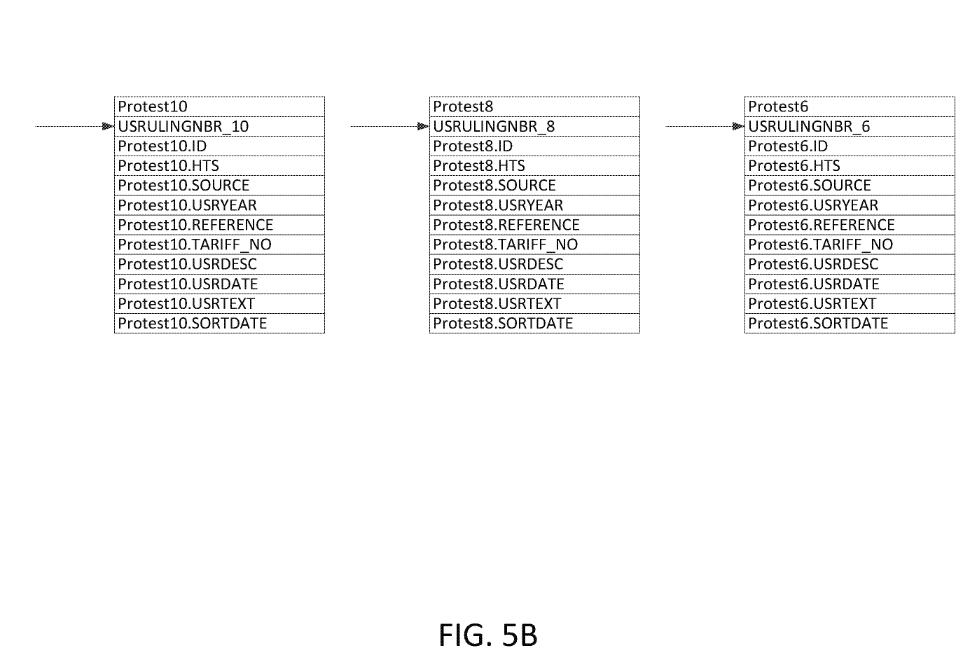

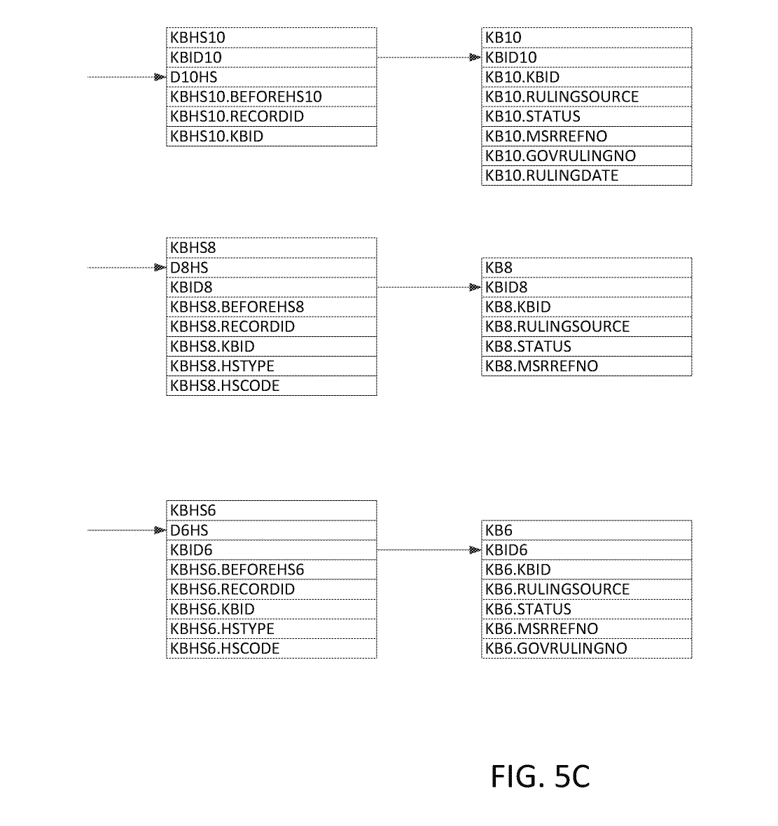

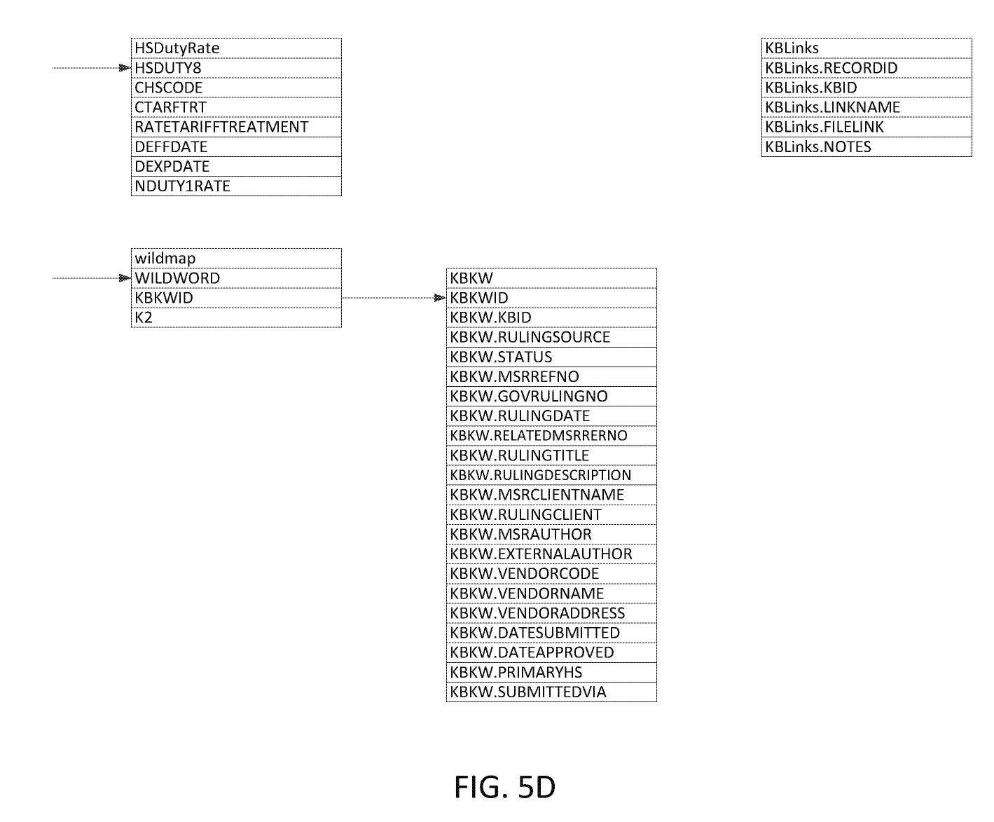

Referring to FIG. 5A, a first table in the database may be a RECORDS table. When a company imports items and files the required data with a government customs agency, they receive back in response a file(s) which contains all the shipment data (e.g., part number, value for duty, duty rate, etc.). The record files may also be obtained from other sources, such as custom brokers or the company itself. Typically, these transactional record files (TRF's) are thousands of lines long, where when combined with other TRF's results in tens of millions of records or more. RECORDS may also contain other fields, generally referred to as “derived fields” which are not native to the TRF where information from the TRF and elsewhere is transformed to provide the links to other tables in the associative database.

The majority of these additional fields may be created based upon the HS Code, which is a ten-digit code associated with a particular item or class of items. For example, each of a white cotton T-shirt or ball bearing assembly would have its own unique HS Code. This code may, in turn, be broken down into the first six digits which is an internationally agreed code for the item. The following two digits of the code break down the classification further for Canadian purposes, and the final two digits are used for statistical purposes. Colloquially, these may be referred to as 6-digit, 8-digit, and 10-digit HS Codes, respectively. Rulings for customs purposes may refer to one of a 6-digit, 8-digit, and/or 10-digit HS Code. In order to accommodate the differences in the HS Codes in an efficient manner the system may include multiple similar tables, including tables in the knowledge base for each level of the HS Code. For example, one manner of including such different tables is illustrated in FIG. 5C using KBHS6, KBHS8, and KBHS10.

As illustrated in FIG. 5C, each of the KBHS“x” tables contains a link to the RECORDS table (D“x”HS), where “x” is 6, 8, or 10. In addition, the KBHS“x” tables also may contain a link to a KB“x” table, this link may be provided by way of KBID“x”.

The “knowledge base” includes a set of tables that contain rulings from various entities, such as CITT (Canadian International Trade Tribunal), MSR, EU (European Union), etc. In each case, in addition to providing the actual rulings relevant keywords may be extracted and stored in the database to use for queries.

The KBHS“x” and KB“x” tables may be grouped by the HS Code's length (e.g., 6, 8, and/or 10 digits). There are two tables for each code length, a “KBHS” table and a “KB” table. Each KBHS table contains the “BEFORE” HS Code of appropriate length (where “BEFORE” signifies the original and presumably higher duty rate of the class the item was assigned to when preparing the TRF, and links to the RECORDS file and the KB“x” table for that length of code. The “KBx” tables tend to be much larger, and contain ruling data, such as Ruling Source, Stats, MSR Reference Number, etc. They also contain the “AFTER” HS Code. When the part is resubmitted, it will use this code instead of the BEFORE code.

Referring to FIG. 5B, the US Rulings (“Protest”) tables may be similar in design and data to the KBHS tables. These may be in a different format and structure than the KBHS Tables.

Referring to FIG. 5D, the KeyWord Tables may be separated into two tables. The first is a knowledge base keyword table which contains the metatdata for rulings (source, date, status, title, etc.). The second is a wildword table which adds one or more “wildcard” characters (“*”) to each keyword. A wildcard character allows matches when the keyword is contained within the text of a target word, for example the WildWord “*truck*” would match against “dump truck”, “food truck”, and “garbage truck”. This creates a greater number of matches within the database and gives the auditor more rulings which may be applicable to any particular case. In addition, by having pre-defined wildcard searches provides for greater consistency between different auditors.

Referring to FIG. 5D, a KB Links table provides a link to the text of the actual ruling so that if an auditor wants more information or detail, the auditor may quickly access the information.

The system may further include B2 tables that include data as submitted to government customs agency originally, such as the Value For Duty, Duty Rate Applied, Duty Amount Paid, etc.

The system matches data from various rulings to the RECORDS table. This facilitates the system to find likely suitable reclassifications of an item from one HS Code to another HS Code (presumably, the later has a lower or zero duty rate). By linking rulings from various sources to the RECORDS table, this facilitates auditors to see all (or a significant set of) suitable rulings at each of the 6-digit, 8-digit, and 10-digit HS levels, and determine which, if any, are likely to apply to the item in question. This process alleviates the auditor from having to remember all of the rulings and the HS codes to which they apply and to more likely ensure that the reclassification process considers all the likely possibilities (based upon the database).

By way of example, presume that an item has a HS Code 9999123456. The 6-digit code in the records file, D6HS would be 999912, the 8 digit code in the records file, D8HS would be 99991234, and the 10 digit code in the records file, D10HS would be 9999123456. These codes link to the field of the same name in the KBHS“x” records.

Each of the KBHS“x” files is linked by a different field, KBID“x” to the knowledgebase ruling files, which have names KB“x”. These ruling files contain data such as ruling source, date, status, reference number, etc. In this manner, once the auditor selects a single HS Code, the system automatically identifies all the rulings associated with that HS Code at each of the 6-digit, 8-digit, and/or 10-digit levels using a single query. Thus, as new rulings are issued and added to the database, the system may automatically associate them with the RECORDS file via the HS Code fields. This identifies existing custom entry documents which may be candidates for duty drawback. With the system also maintaining links to the images (or otherwise) of the customs entry documents, the auditors may pull up both the text of the ruling and the original customs entry document to determine if the suggested ruling applies to that particular item.

As part of the reclassification system and the identification of suitable rulings, one or more keywords may be used. The HS Code classification process may be rather broad, especially at the 6-digit level. As a result of the rather broad classifications, the auditors may in the process of reviewing a file insert “keywords” into one field of the RECORDS file. As each new ruling is entered into the knowledgebase, it also contains “keywords”. While the matching of the keywords is beneficial, it is also further desirable to include one or more wildcard search characters within the database. Each of the keywords for the rulings within the database may also be duplicated and include a wildcard character at the front of the keyword and/or at the end of the keyword. Moreover, the wildcard character may be included within the keyword, if desired. For example, if the keyword was “battery”, and the wildword was “*battery*” (where “*” indicates the wildcard character) then it would match “LiOnbattery”, “car battery”, etc. if such search terms were entered by an auditor. Each of the wildwords is linked to a ruling in the knowledgebase, so that if the auditor has entered “battery” as a keyword while reviewing the customer data, this wildword would link to all rulings that have the keyword “battery” within. This assists in ensuring a more complete review and reduces the need to a particular auditor to know, or to otherwise be apprised of, the latest rulings entered into the knowledgebase.

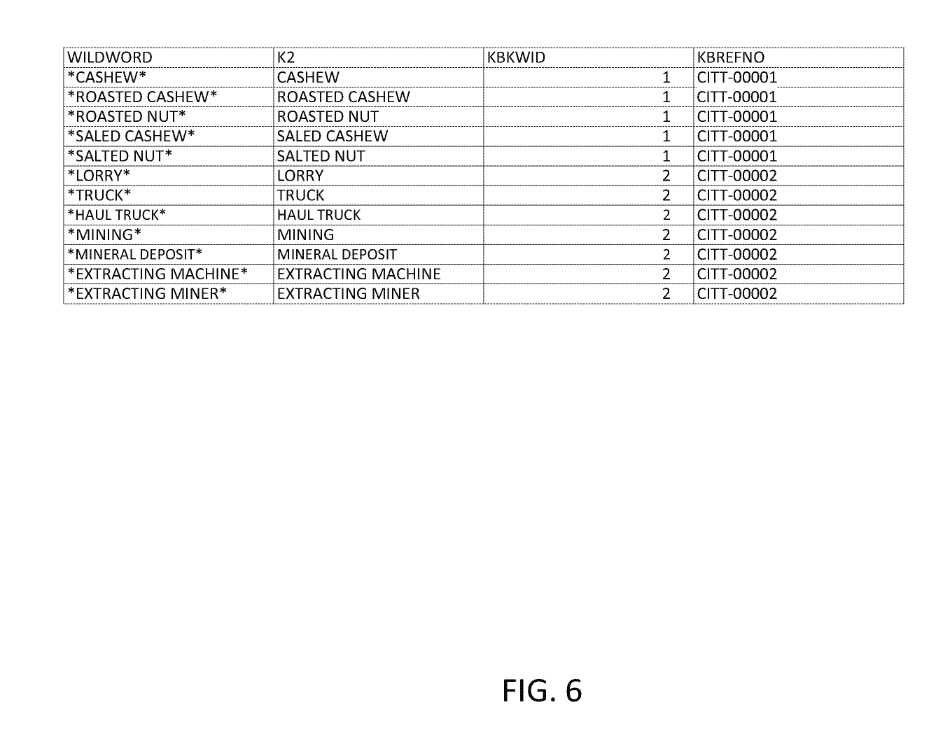

To provide increased flexibility in the query of the database, it is desirable to include the wildword string and a pair of functions, one to map the KEYWORD from the knowledgebase to the records file and another to map the appropriate ruling reference number. In this manner, a table may be created of all the ruling keywords and the appropriate ruling reference numbers, referred to herein as the “wildmap”. By way of example, the wildmap table may be as illustrated in FIG. 6.

To facilitate the comparison of two (or more) multi-varied fields from different tables and find all the matches between them, a mapping may be used between the wildmap table and the records table. This may be performed, for example, by creating a pair (or more) of additional variables, namely vMapKey and vMapLabel, which refer to the wildword and the MSRREFNO, respectively. vMapKey may be a concatenation of the wildwords from the wildmap table, while vMapLabel may be a concatenation of the reference numbers. This means that both variables ultimately contain a value from every keyword in the knowledge base. Using the data base, here is what the first few entries may look like for FIG. 6:

vMapKey=*CASHEW*, *ROASTED CASHEW*, *ROASTED NUT*, *SALTED CASHEW*, *SALTED NUT*, *LORRY*

vMapLabel=CCIT=00001, CITT-00001, CIT-00001, CITT-00001, CITT-00001, CITT-00002

etc.

The two variables, described above, are used when the records table is loaded from the TRF's. User defined functions may be used to map the wildwords and reference numbers from the wildmap table to the records table. The first of these functions uses vMapKey to find a matching value in the keywords field of the records table, and maps the appropriate reference number into a new field called MSRREFNO. The second of these functions uses vMapKey to find a matching value, in the keywords field and maps the ‘wilded’ version of the keyword into a new field in records called “WILDWORD”. These fields facilitate the association of data in the records table to the data in the knowledgebase table. These two links facilitate the interrelationships between the records table and the knowledgebase.

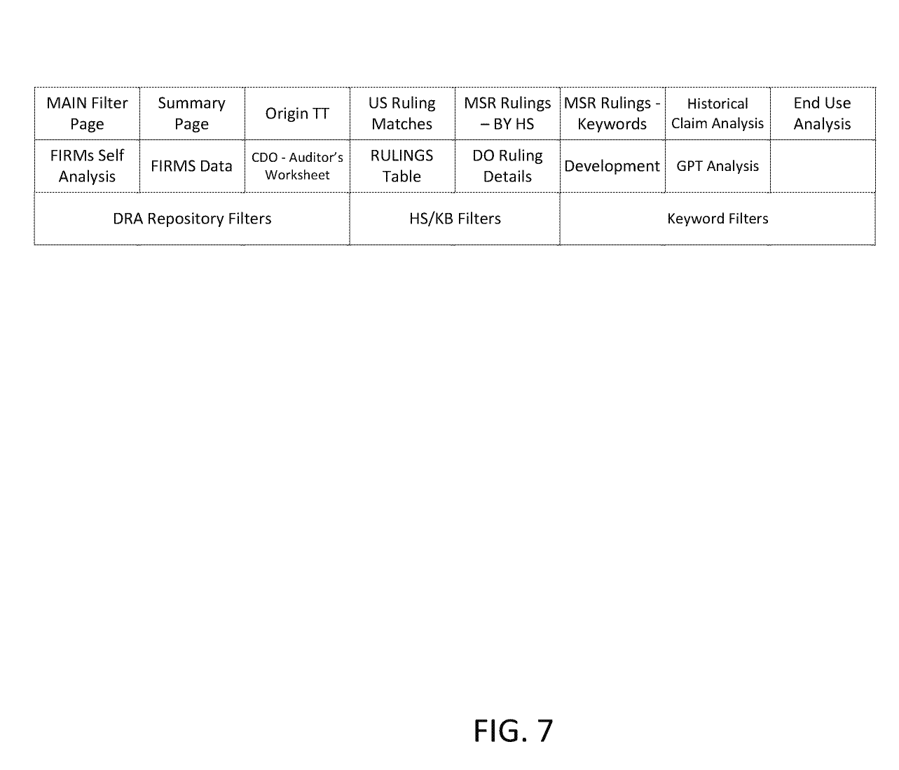

Referring to FIG. 7, the system may include an interface displayed on a computer screen as a result of a program running on a computer system together with storage for the database and other items. The interface may include a number of different tabs, each of which is selectable by the user, to facilitate the access to different features. In particular, one of the tabs includes “DRA Repository Filters”, another of the tabs includes “HS/KB Filters” (HS and knowledgebase filters), and another of the tabs includes “Keyword Filters”. Each of these sections may be of assistance in the analysis seeking the data desired to conduct an audit. Each of the sections provides a different manner of seeking information for a suitable audit.

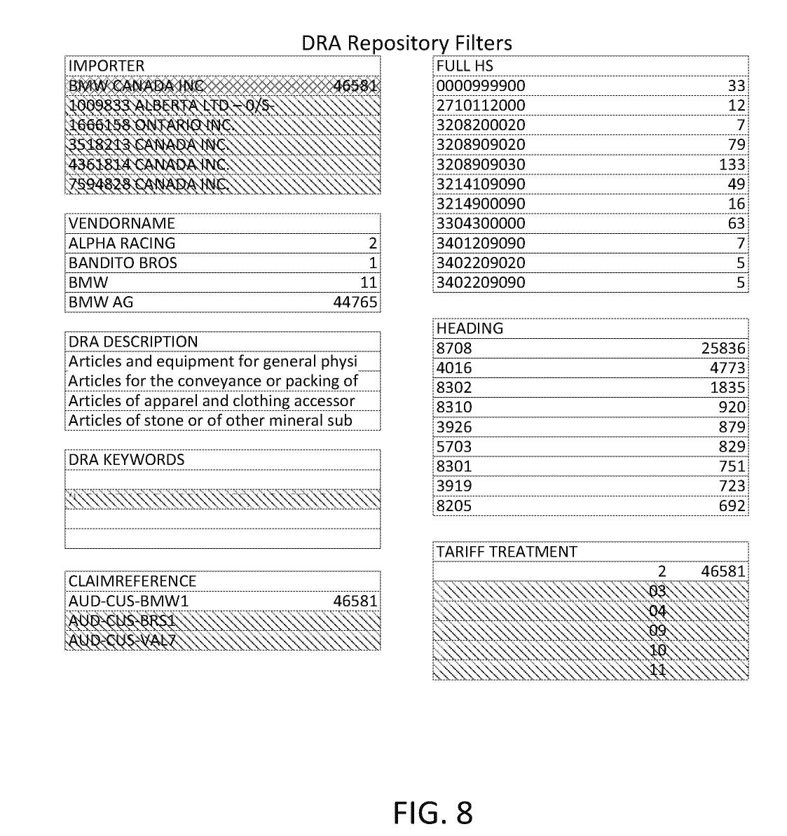

Referring to FIG. 8, the tab DRA Repository Filters may be selected which provides an interface that includes many of the different entries in the tables. The auditor may narrow the search by selecting any or all of the filters to narrow down the importer(s), vendor(s), HS Codes, etc. With the selection made to one or more of the filters, such as BMW CANADA INC. in the IMPORTER field, then the system may automatically update the remaining fields to change the contents being displayed to that which corresponds to the selected field(s). The display may further display the content in a manner where content with different characteristics may be readily distinguished from one another. By way of example, the BMW CANADA INC selected by the auditor may be “green” to indicate it is a value selected directly by the auditor. By way of example, content shown with a “grey” background are not associated with the selection by the auditor. By way of example, content shown with a “white” background are items which are associated with the selection by the auditor. For example, all the “DRA Keywords” entries are illustrated as “grey” in FIG. 8 which means that there are no keywords associated with the selected importer. For example, the only tariff treatment that applies is “2”, as it is the only one in white, while all other possible tariff treatments are shown as “grey” (i.e. not application for the selected importer).

The filter boxes also contain integers on the right hand side. These indicate how many items there are associated with the main selection. For example, “Vendorname” filter, it is noted that most lines (44765) are products imported directly from BMW AG in Germany. It is noted that the total number of lines is shown in the “Claimreference” filter (46581).

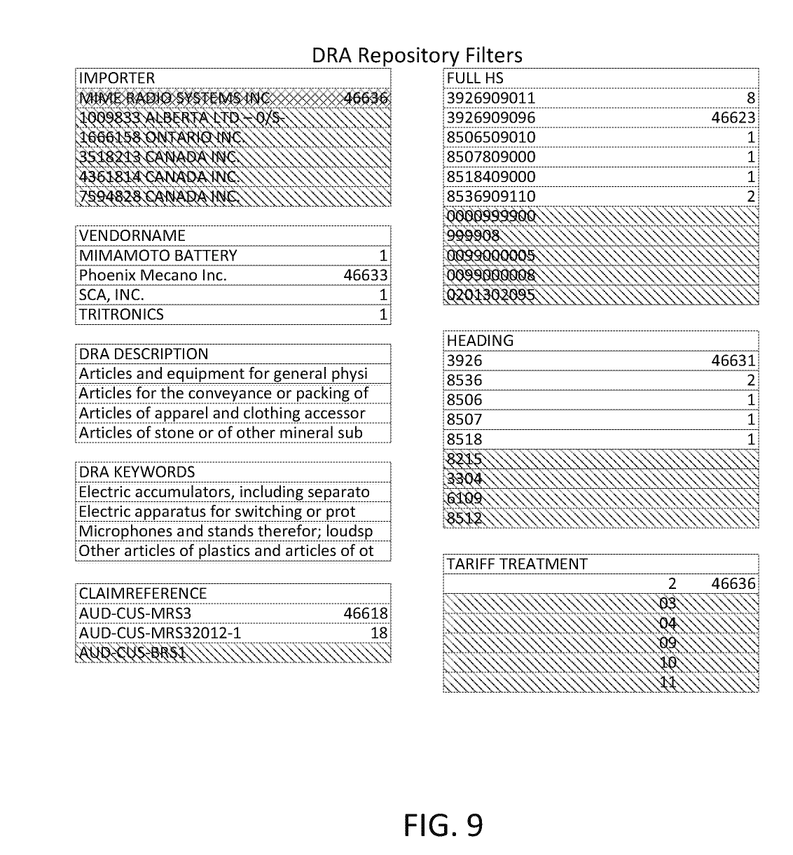

Referring to FIG. 9, by way of example it may be observed that virtually all the parts imported by “MINE RADIO SYSTEMS INC” come from Phoenix Mecano, that being “BATTERIES” and “PLUSTIC LOCK NUT” are present, and that all but five lines come under one “Heading” (first four digits of the HS Code). If the auditor then selects the “Full HS” value 3926909096, then values show up in all the areas.

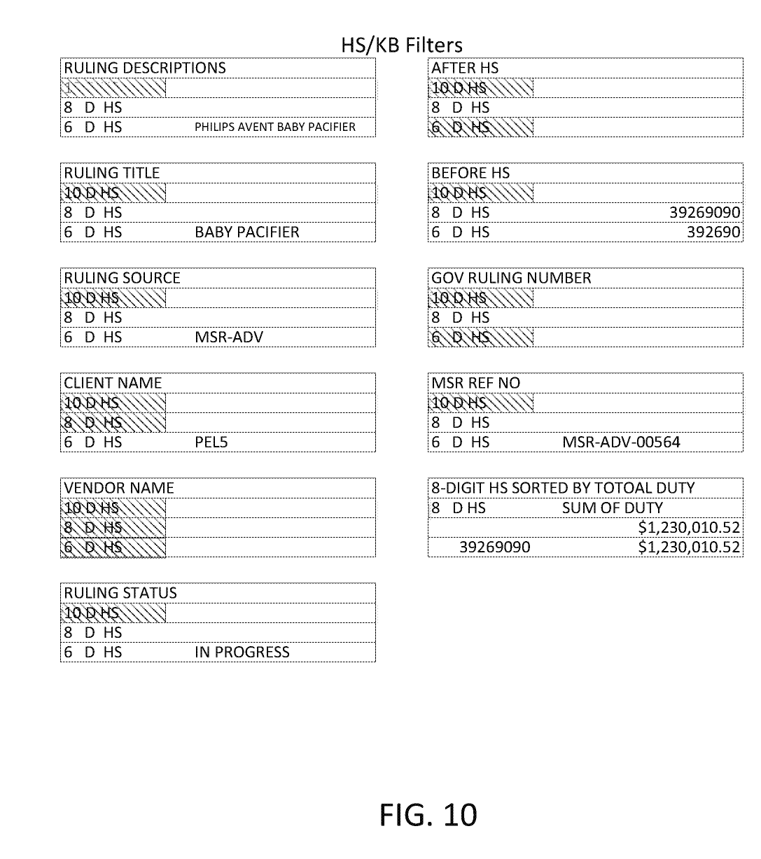

Referring to FIG. 10, the HS/KB Filters illustrate some potentially disappointing information, where the only ruling associated with that HS Code is for a baby pacifier which is unlikely applicable to a radio system. As a result, the auditor may choose not to go forward with the audit as there is apparently not a likely opportunity. However, the lack of a likely opportunity may be revealed in a short period of time thus saving hours or perhaps days of sorting through thousands or tens of thousands of lines.

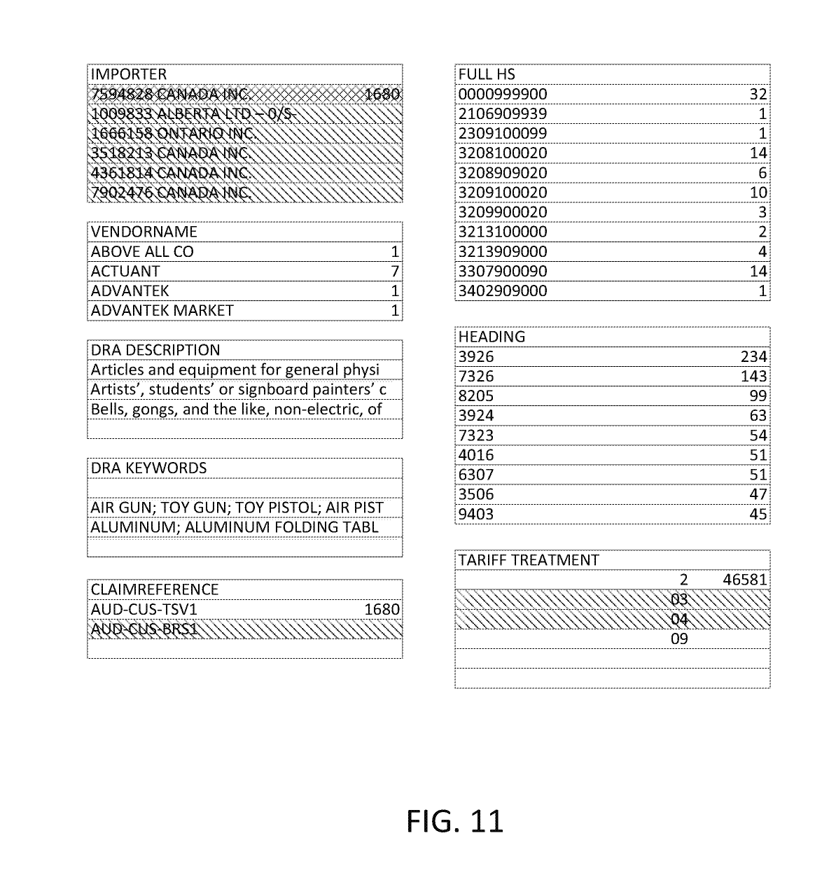

Referring to FIG. 11, the HS/KB Filter may be used to observe that many different HS Codes and vendors are available from the particular importer.

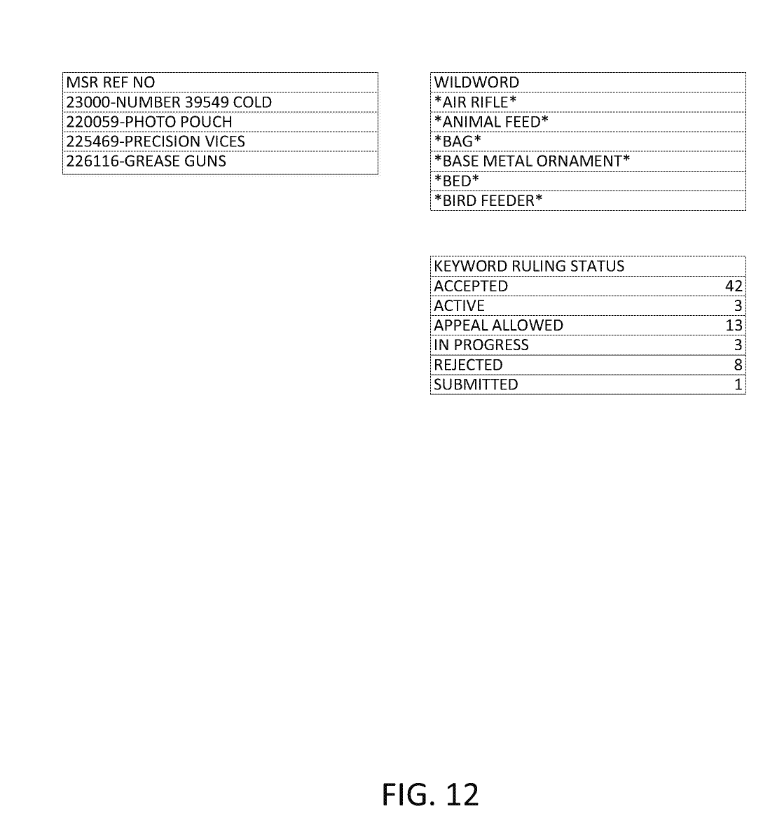

Referring to FIG. 12, the Keyword Filter may illustrate that there are a number of rulings that are available (all shown in white), for a significant variety of products (as shown by the range of keywords), and that the ruling status is favorable, as almost all rulings are successful. With this information, the auditor can return to the DRA Filters and look through the various HS Codes until the auditor finds one that has a significant amount of duty and a ruling that appears to be favorable. At this point, the auditor can look at the other tabs to determine what might be claimed.

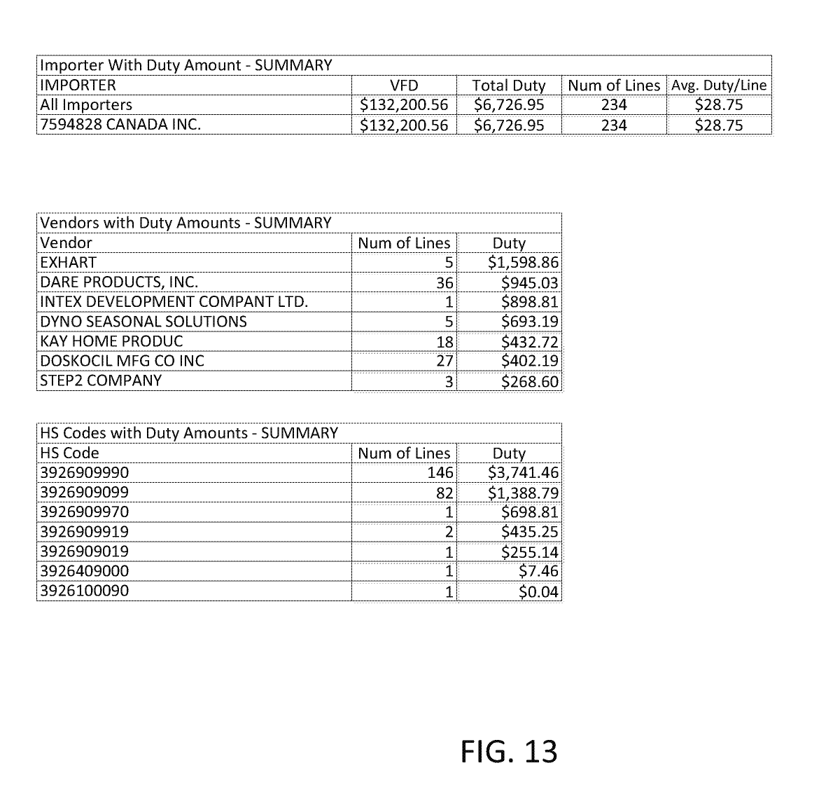

Referring to FIG. 13, it may be observed for the HS heading selected, there are a number of vendors, each with a distinct set of liens and duty amounts associated. In the case illustrated above, the auditor has already selected an importer, but if the auditor had started by selecting one HS code, there could be many importers shown. This page shows the auditor that there is sufficient duty available to be reclaimed that warrants further review.

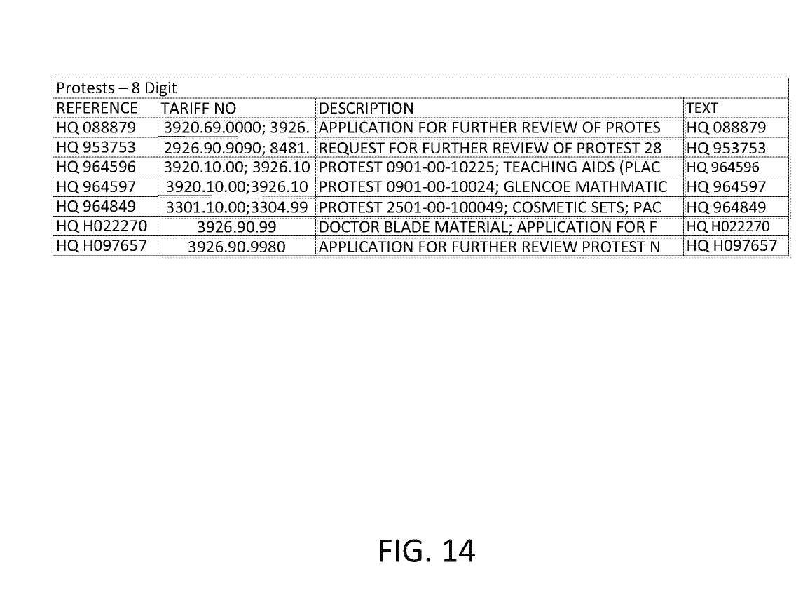

Referring to FIG. 14, it may be observed that selecting the US Ruling Matches tab, there are a number of US rulings that might be applicable. The description allows the auditor to select appropriate rulings among the set of rulings for further review.

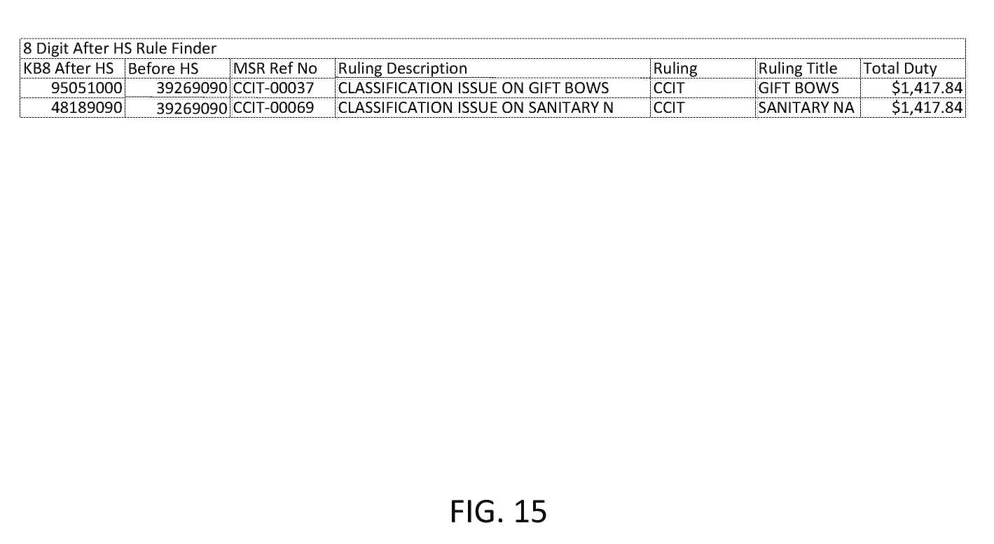

Referring to FIG. 15, it may be observed which Rulings are associated with which HS Code. Note, that the display shows both the “Before” HS code (originally submitted to the agency) and the “After” code (new code part which will be submitted under for the claim). An experienced auditor may have internalized many rulings, HS Codes, etc., and tends to be able to quickly determine whether a particular ruling is applicable to the importer and/or parts under consideration.

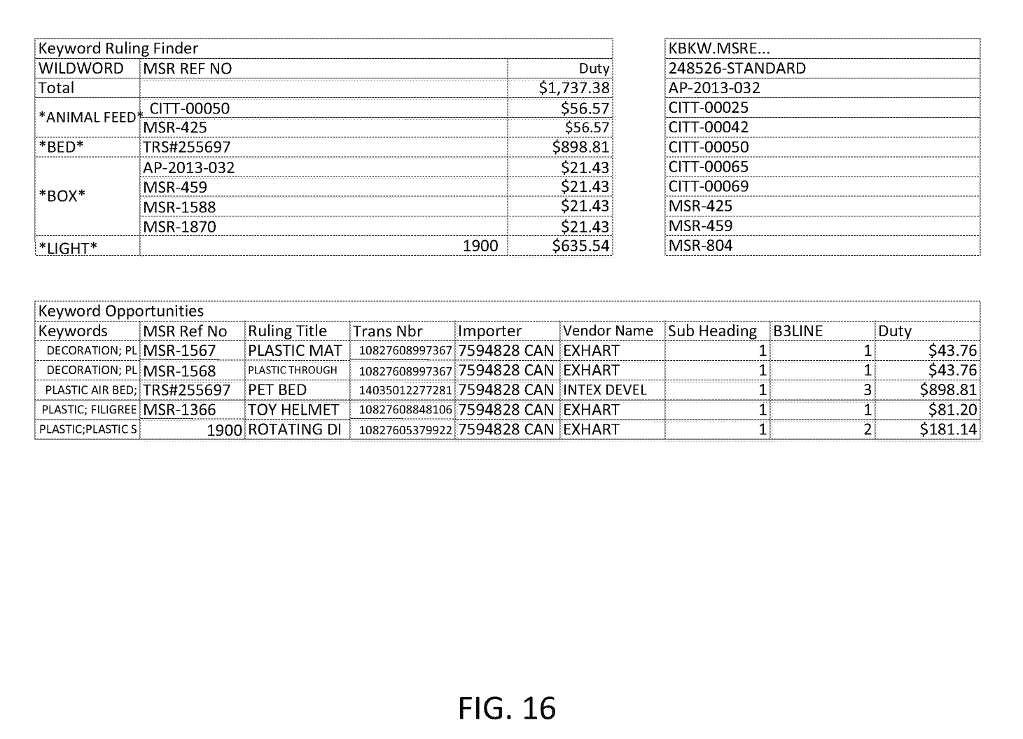

Referring to FIG. 16, the Rulings show the matches based on the keywords. There are many matches, as the keyword “plastic” matches “plastic bed”, “plastic air bed”, “plastic solar garden”, etc. In addition, contextual searches may be included to provide more meaningful keyword results.

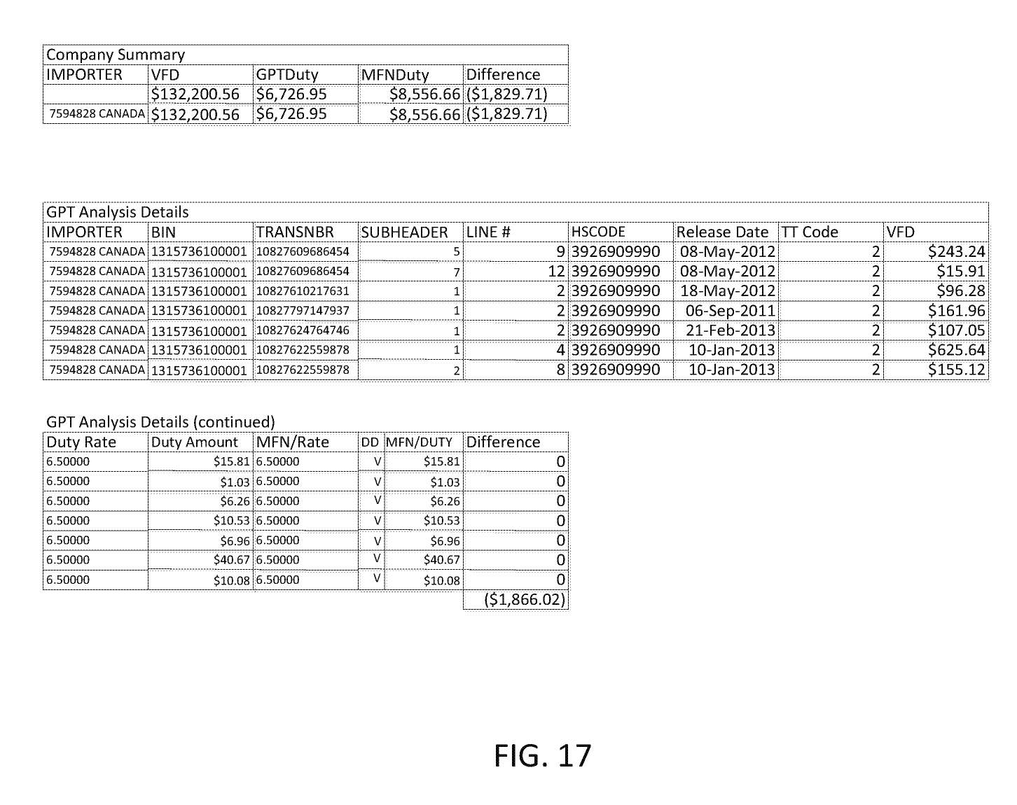

Referring to FIG. 17, the GPT analysis tab may examine the impact of changing an import's status from a most favored nation to general preferential tariff. The system may look at each line, determine if it is eligible for a most favored nation, then apply the updated general preferential tariff rate. The system may then calculate the new duty and show the savings.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1-14. (canceled)

15. A system for identifying duty recovery opportunities of purchased goods by a buyer from a seller comprising:
(a) a computer system including an associative customs information database having records configured to record transaction information identifying said purchased goods, a customs classification of said purchased goods, and a valuation of said purchased goods, where all such said records of said purchased goods, said customs classification of said purchased goods, and said valuation of said purchased goods are related to one another in such a manner that said all such said records do not need to be joined for a specific query;
(b) said computer system including an interface configured to receive said identifying said purchased goods, said customs classification, and said valuation based upon selecting one of said all such said records of said purchased goods, said customs classification of said purchased goods, and said valuation of said purchased goods without said need to be joined for a specific query;
(c) said computer system selecting a first set of said purchased goods for said duty recovery opportunity, where said first set of said purchased goods are determined based upon said customs classification and information in addition to an entry packet associated with said purchased goods that are likely to result in a duty change;
(d) said computer system selecting a second set of said purchased goods that is a subset of said first set of said purchased goods for said duty recovery opportunity, where said second set of said purchased goods are determined (1) based upon omitting selected items that are likely to result in said duty change, (2) based upon supporting documentation related to said purchased goods, (3) based upon a reclassification of said customs classification of said purchased goods.

16. The system for identifying duty recovery opportunities of claim 15 wherein said computer system updating said customs information database based upon said second set of said purchased goods.

17. The system for identifying duty recovery opportunities of claim 16 wherein said computer system configured to generate said customs documents reporting information from said customs information database based upon said identifying said purchased goods, said customs classification, and said valuation based upon said second set of said purchased goods.

18. The system of claim 15 wherein said customs classification is consistent with a harmonized tariff schedule.

19. The system of claim 15 wherein said customs information database has records configured to record a country of origin related to said purchased goods.

20. The system of claim 15 wherein said customs information database has records configured to record anti-dumping duties related to said purchased goods.

21. The system of claim 15 wherein said customs information database has records configured to record countervailing duties related to said purchased goods.

22. The system of claim 15 wherein said customs information database has records configured to record trade agreements related to said purchased goods.

23. The system of claim 15 wherein said customs information database has records configured to record an updated quantity of said purchased goods,

24. The system of claim 15 wherein said customs documents are for a duty recovery.

25. The system of claim 15 wherein said duty recovery is for at least one of (1) rebate of duty chargeable on imported material; (2) rebate based upon excisable material used in a manufacturing of goods; (3) rebate based upon material used for the manufacture of export products; (4) rebate based upon re-import of goods; (5) rebate based on packing material; (5) rebate based upon unused duty suspensions.

26. The system of claim 15 said duty recovery is based upon customs tariff reclassification.

27. The system of claim 15 said duty recovery is based upon a change in the number of said purchased goods.

28. The system of claim 15 said duty recovery is based upon a change in an identification of component goods of said purchased goods.

29. The system of claim 15 wherein said duty recovery is based upon customs agency rulings.

30. The system of claim 15 wherein said duty recovery is based upon customs agency rulings that occurred after said purchased goods were imported.

31. The system of claim 15 wherein a first table of said associative customs information database includes said all such said records of said purchased goods, said customs classification of said purchased goods, and said valuation of said purchased goods.

32. The system of claim 31 wherein said first table of said associative customs information database further includes links to additional tables, where said links are based upon information within said first table.

33. The system of claim 32 wherein said links are based upon harmonized tariff codes.

34. The system of claim 33 wherein said links are based upon at least one of a 6 digit said harmonized tariff code, an 8 digit said harmonized tariff code, and a 10 digit said harmonized tariff code.

35. The system of claim 34 wherein a first one of said additional tables includes a set of 6 digit said harmonized tariff codes for a first set of items.

36. The system of claim 35 wherein a second one of said additional tables includes a set of 8 digit said harmonized tariff codes for a second set of items.

37. The system of claim 36 wherein a third one of said additional tables includes a set of 8 digit said harmonized tariff codes for a third set of items.

38. The system of claim 37 wherein said first one of said additional tables further includes duty rates for said first set of items.

39. The system of claim 24 wherein said second one of said additional tables further includes duty rates for said second set of items.

40. The system of claim 39 wherein said third one of said additional tables further includes duty rates for said third set of items.

41. The system of claim 39 wherein said first one of said additional tables further includes links to a fourth one of said additional tables.

42. The system of claim 40 wherein said second one of said additional tables further includes links to a fifth one of said additional tables.

43. The system of claim 41 wherein said third one of said additional tables further includes links to a sixth one of said additional tables.

44. The system of claim 43 wherein said fourth one of said additional tables contain ruling data related to said first set of items.

45. The system of claim 44 wherein said fifth one of said additional tables contain ruling data related to said second set of items.

46. The system of claim 45 wherein said sixth one of said additional tables contain ruling data related to said third set of items.

47. The system of claim 46 wherein said fourth one of said additional tables contain a first updated duty rate for said first set of items.

48. The system of claim 47 wherein said fifth one of said additional tables contain a second updated duty rate for said second set of items.

49. The system of claim 48 wherein said sixth one of said additional tables contain a third updated duty rate for said third set of items.
